(19) United States
(12) Patent Application Publication
(10) Pub. No.: US 2006/0272511 A1
(43) Pub. Date: Dec. 7, 2006

(54) Electric cooking apparatus having interchangeable cooking inserts and method for using same

(76) Inventors: Samantha Dreimann, Lake Forest, IL (US); Guillaume Jean Since, Hong Kong (CN)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/355,481

(22) Filed: Feb. 15, 2006

Related U.S. Application Data
(60) Provisional application No. 60/663,693, filed on Mar. 21, 2005.

(51) Int. Cl. A47J 37/06

(52) U.S. Cl. 99/372

(57) ABSTRACT

A cooking device comprising an upper housing, a lower housing, a first and second pan inserts and a heating unit is disclosed. The lower housing is pivotally connected to the upper housing. The lower housing a cooking well. The first pan insert is removably insertable into the lower housing. The heating unit is disposed in at least the lower housing.

This patent application claims priority to U.S. provisional application Ser. No. 60/663,693, filed Mar. 21, 2005, which is incorporated herein by reference in its entirety.

### BACKGROUND OF THE INVENTION

1. Technical Field

The invention relates to kitchen appliances generally and, in particular to an electric cooking apparatus having interchangable cooking inserts.

2. Related Art

Table-top cooking devices today provide consumers with a portable, convenient, efficient and space-saving appliance. An example of such a table-top cooking device is described in U.S. Pat. No. 5,606,905 directed to an electric countertop grill having upper and lower grill plates that are connected by a hinge in a clamshell arrangement. The user places a food item on the lower grill plate and then closes the upper grill plate down upon it. The cooking space created by this configuration generally allows for cooking of both sides of the food item simultaneously and more quickly. Electric grills of this type continue to enjoy significant commercial success and they have become the cooking appliance of choice for many consumers.

These grills generally accommodate pre-formed or discrete foodstuffs for cooking. There is a need for a similarly convenient cooking device to assist in making foods that require a form to create loafs, bars, cakes and the like through a simple cooking process. There are other needs and uses for such a device as will become apparent to those of skill in the art having the present specification before them.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 shows a cooking appliance according to the present invention with a bar pan insert removably located in the cooking well.

FIG. 2 shows the cooking appliance of FIG. 1 with the bar pan insert removed.

FIGS. 3A, 3B and 3C depict three exemplary insert forms for use in the cooking appliance of FIG. 1.

FIG. 4 shows the cooking appliance of FIG. 1 with the top lid closed over a pan insert removably located in the cooking well.

FIG. 5 shows the cooking appliance of FIG. 1 with a mini roll-up pan insert removably located in the cooking well.

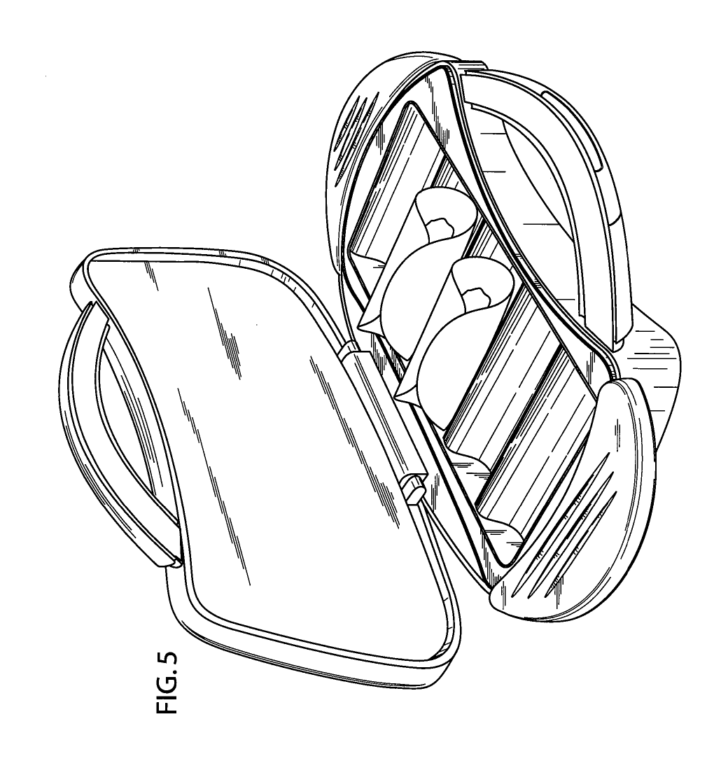

### DETAILED DESCRIPTION OF THE EXEMPLARY EMBODIMENTS

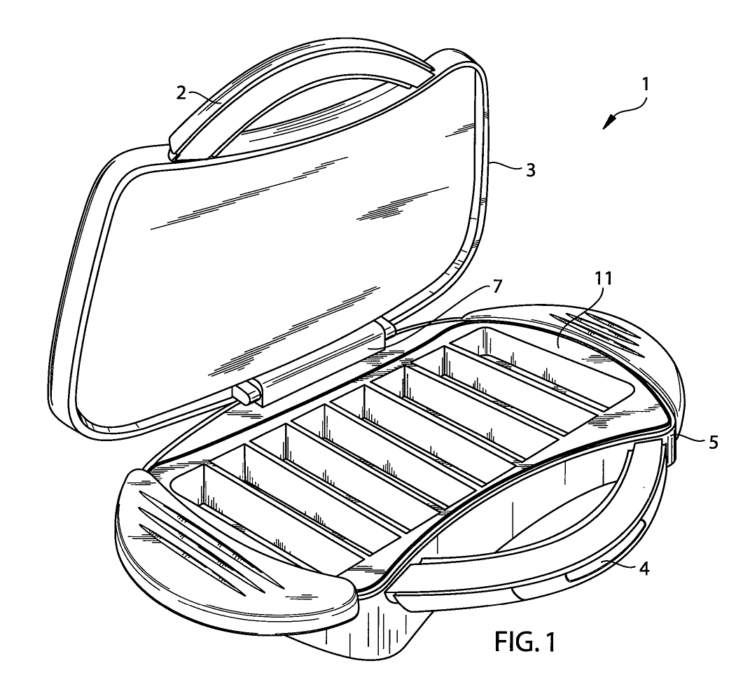

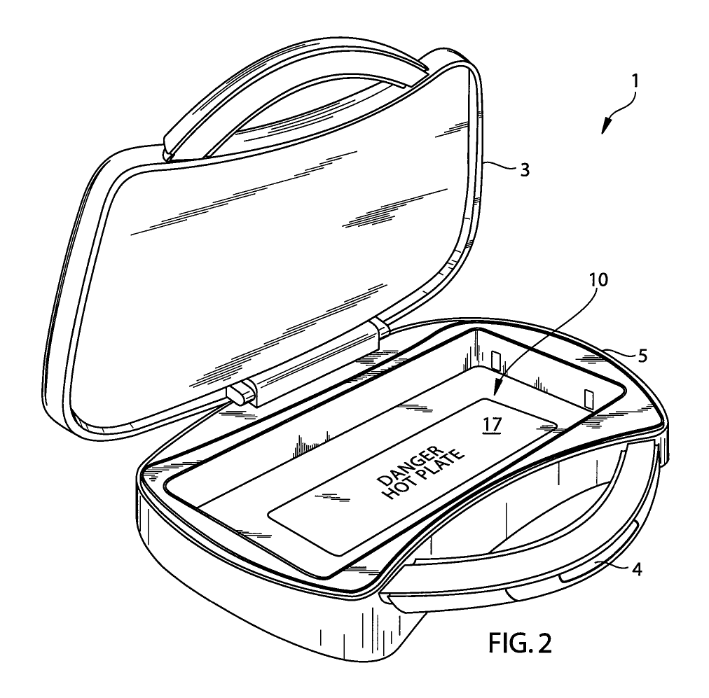

Referring to the Figures, according to a preferred embodiment of the present invention, a cooking appliance 1 is shown which includes an upper housing 3 and a lower housing 5 pivotally connected by a connecting unit 7. The connecting unit 7 interconnects the lower and upper housings 3, 5 in such a manner that the upper housing 3 can be turned rearward from the lower housing 5 to an open position, in which the upper and lower housings 3, 5 are generally disposed at an obtuse angle between each other, as best shown in FIG. 1. As shown in FIG. 1, one of a plurality of pan inserts 11 may be removably disposed in the cooking well 10 of lower housing 5 (see FIG. 2) during normal operation of the cooking appliance 1.

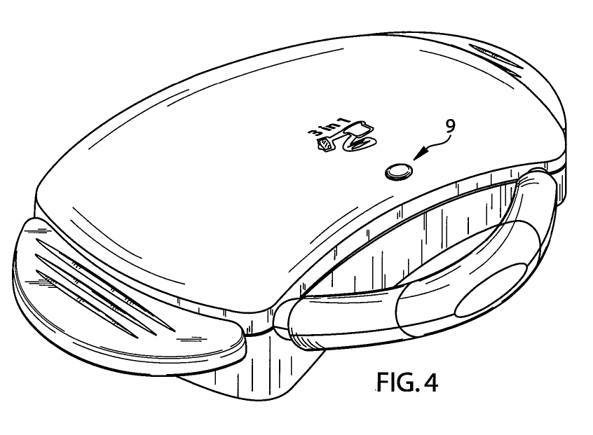

In a preferred embodiment, the lower housing 5 is connected to a power source via a conventional power cord (not shown), and the upper housing 3 is preferably electrically coupled to the lower housing 5 via the connecting unit 7. However, other approaches to powering the apparatus are also possible, such as for example, a battery source or liquid or solid fuel sources. The upper housing 3 may include user input controls (not shown) for controlling the apparatus 1, such as for example, the power or temperature at which a food item will be cooked. The input controls may include a count-down timer that shuts off power to each of the heating units when it reaches zero. It is also contemplated that cooking device 1 in its most basic form may only include power indicator light 9 (FIG. 4) to indicate to end user that cooking device 1 is energized and hot. Upper and lower housings may further include handles 2 and 4. In the embodiment depicted, the handles substantially overlay one another when the upper and lower housings are closed together. The handles may further include a locking mechanism to provide downward pressure on the cooking foodstuffs to assist in forming the food shapes.

FIG. 2 shows one potential embodiment of the cooking device 1 with pan insert 11 removed from in lower housing 5, thus exposing cooking well 10. As depicted, cooking well 10 is preferably substantially rectangular, however, other shaped wells may be used so long as cooking well 10 forms a three-dimensional volume sized to receive each of the pan inserts 1I1 individually. Pan insert 11 may only be held in cooking well 10 by force of gravity. In the device depicted in FIG. 2, at least the lower housing 5 includes a fixedly attached heating unit disposed so as to be thermally coupled to the bottom of pan insert 11 when the insert is operably disposed in the cooking well 10.

In the depicted embodiment, the heating unit includes a heat conductive plate 17 to which a heating element (not shown) is attached. This heat conductive plate 17 acts as a heat sink that absorbs heat from the heating element and then more uniformly distributes the heat to the pan insert 11 than would be possible with just a heating element. The heating unit is preferably disposed substantially in the center of the lower housing 5 in a cavity formed in the lower housing generally below the cooking well 10. This cavity should be completely covered by the heat conductive plate. Further, the heat conductive plate may cover the entire bottom of cooking well 10. It may also be desirable for some end uses to provide heating elements associated with the upright walls of cooking well 10. In such instances, the control for the cooking device 1 may provide the ability to selectively actuate the side-wall heating elements. Similarly, upper housing 3 may also include an upper heating unit substantially similar to the heating unit in the lower housing. Here again, it would may be desirable to provide for the control of cooking device 1 to selectively actuate the upper heating unit. Further, it is contemplated that each heating unit may include a thermally-controlled switch that can energize and/or de-energize the heating element to avoid undesirable heating situations. In a preferred embodiment, each heating unit may also have an associated safety interlock mechanism which automatically de-energizes the heating element when no pan insert 11 is disposed in the cooking well 10.

As illustrated, the heat conductive plate 17 protects an end-user from risk of direct contact with the heating element even when the pan insert 11 is not on the lower housing 5. The use of the heat conductive plate also substantially prevents food debris, oil, grease, or other substances from becoming lodged on or beneath the heating element and provides a thermal mass that operates to moderate the thermal input from the heat source, thus providing a uniform distribution of heat to the pan insert. Nonetheless, it is possible to omit the heat conductive plate from cooking device 1 and use only the heating bare element.

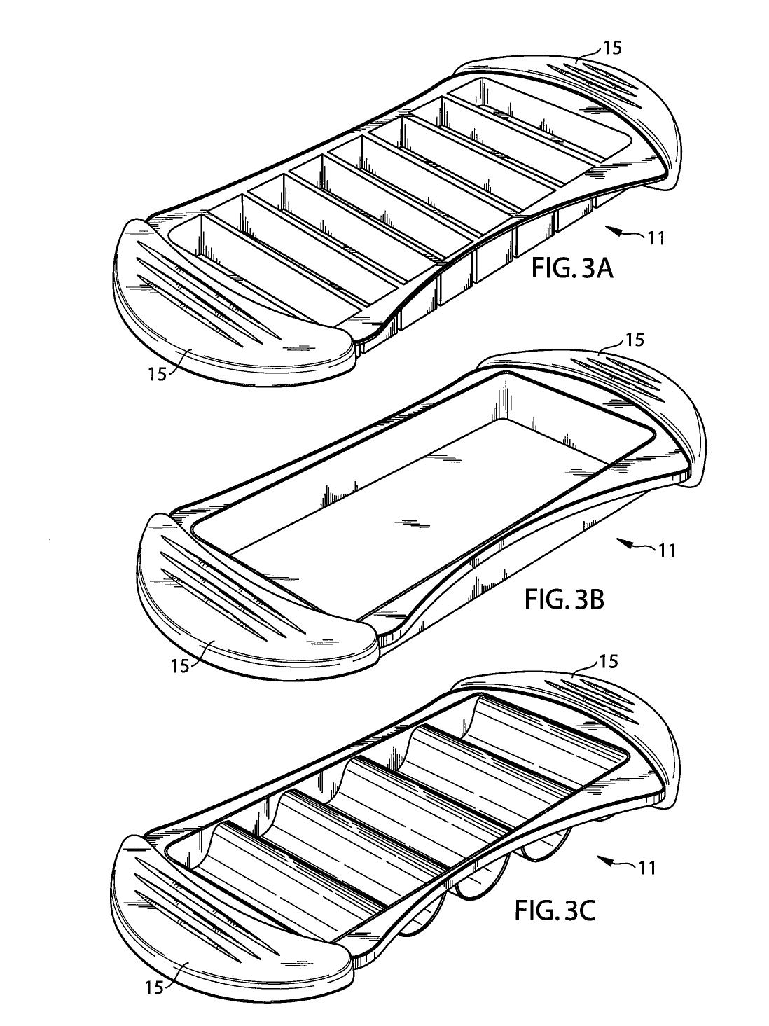

FIGS. 3A, 3B and 3C depict three potential pan inserts 11A, 11B and 11C, respectively, that may be included in cooking device 1. Each of the pan inserts 11 have two substantially heat-resistant handles 15 disposed at opposing ends of the insert to facilitate removal of the pan by an end user even while the pan, itself, may still be hot. As depicted the handles 15 may have ridges to improve the user's grip on the handles. Further, the handles may be formed from a pliable material (e.g. rubber) to improve user comfort and safety in handling the pan inserts 11. Moreover, heat-resistant handles 15 may be removably attached to the pan inserts 11 by a snug fit or mechanical means (e.g. mating tabs and holes). In that manner, a single pair of heat-resistant handles 15 may be provided with cooking device 1 to be temporarily mounted on the particular pan insert 11 in use at the time from the plurality of pan insert included with the device.

Each of the pan inserts (see FIGS. 3A, 3B and 3C) has a cooking region bounded by the outer sides of the pan insert. Although all of the pan inserts depicted have a generally rectangular outer silhouette, it is contemplated that any shape may be used for the pan inserts so long as the pan insert fits within the cooking well of the bottom housing 5. For instance, one of the pan inserts may be configured to facilitate cooking omelets. In another example, a pan insert with grilling surfaces disposed periodically across the bottom may add further versatility to cooking appliance 1. Such a pan insert could have a slight slope toward one edge of the pan insert and further include an apertures to facilitate the removal of grease from the grilling foods. If such an option were provided, it is contemplated that the lower housing 5 would have a corresponding aperture and the appliance may further include a drip tray for catching the run-off.

Aside from the heat-resistant handles 15, the remainder of each of the pan inserts will be constructed from heat conductive materials. These materials may be inherently non-stick or a non-stick coating may be applied to the inner surfaces of the pan inserts. Preferably, the pan inserts 11 are constructed from dishwasher safe materials. In one embodiment, the pan inserts 11 comprise steel, iron, or pressed aluminum, or silicone. Given the relatively compact size of the pan inserts 11 they may also make excellent serving pieces for the dining table and storage containers for the refrigerator. Consequently, one or more snug fit lids (not shown) may also be provided with cooking device 1 to provide a substantially air-tight cover to the pan insert 11. Additionally, removal of the removable heat-resistant handles may facilitate the sealing of the pan inserts for food storage.

FIG. 3A depicts a bar pan constructed to cook and form as many as eight individual serving snack bars (e.g. granola, protein or power type bars) or mini cakes (e.g. brownies, mini loafs, etc). Of course, it would be normal for an end user to fill fewer than all eight compartments with batter or other food mixture while utilizing cooking device 1. Moreover, the number of individual serving compartments constructed is a matter of design-choice based on the overall size of cooking device 1 as well as the desired size for the individual serving compartments. FIG. 3B depicts a loaf pan for lasagna, meat loaf, other casseroles, breads, cakes and the like. FIG. 3C depicts a mini roll-up pan for making tortilla/taco snacks, puffs, egg rolls, pigs-in-blankets and the like.

While various embodiments of the application have been described, it will be apparent to those of ordinary skill in the art that many more embodiments and implementations are possible that are within the scope of this invention.

What is claimed is:

1. A cooking device comprising:
an upper housing;
a lower housing pivotally connected to the upper housing, the lower housing having a cooking well;
a first pan insert removably insertable into the lower housing, wherein the first pan insert comprises silicone;
a heating unit disposed in at least the lower housing; and
a second pan insert.
